(19) United States
(12) Patent Application Publication
(10) Pub. No.: US 2007/0217693 A1
(43) Pub. Date: Sep. 20, 2007

(54) AUTOMATED EVALUATION SYSTEMS & METHODS

(75) Inventor: William A. Kretzschmar Jr, Athens, GA (US)

Correspondence Address: TROUTMAN SANDERS LLP, 600 PEACHTREE STREET , NE, ATLANTA, GA, 30308, US

(73) Assignee: TEXTTECH, LLC, Athens, GA (US)

(21) Appl. No.: 11/570,699

(22) PCT Filed: Jul. 2, 2005
(86) PCT No.: PCT/US05/23476

§ 371 Date: Dec. 15, 2006

Related U.S. Application Data
(60) Provisional application No. 60/585,179, filed on Jul. 2, 2004.

(51) Int. Cl. G06K 9/72

(52) U.S. Cl. 382/229

(57) ABSTRACT

This invention uses linguistic principles, which together can be called Collocational Cohesion (CC), to evaluate and sort documents automatically into one or more user-defined categories, with a specified level of precision and recall. Human readers are not required to review all of the documents in a collection, so this invention can save time and money for any manner of large-scale document processing, including legal discovery, Sarbanes-Oxley compliance, creation and review of archives, and maintenance and monitoring of electronic and other communications. Categories for evaluation are user-defined, not pre-set, so that users can adopt either traditional categories (such as different business activities) or custom, highly specific categories (such as perceived risks or sensitive matters or topics). While the CC process is not itself a general tool for text searches, the application of the CC process to large collections of documents will result in classifications that allow for more efficient indexing and retrieval of information. This invention works by means of linguistic principles. Everyday communication (letters, reports, emails-all kinds of communication in language) does follow the grammatical patterns of a language, but forms of communication also follow other patterns that analysts can specify but that are not obvious to their authors. The CC process uses that additional information for the purposes of its users. Any communication exchange that can be recognized as a particular kind of discourse may be used as a category for classification and assessment. Specific linguistic characteristics that belong to the kind of discourse under study can be asserted and compared with a body of general language, both by inspection and by mathematical tests of significance. These characteristics can then be used to form the roster of words and collocations that specifies the discourse type and defines the category. When such a roster is applied to collections of documents, any document with a sufficient number of connections to the roster will be deemed to be a member of the category Larger documents can be evaluated for clusters of connections, either to identify portions of the larger document for further review, or to subcategorize portions with different linguistic characteristics. The CC process may be extended to create a roster of rosters belonging to many categories, thereby increasing the specificity of evaluation by multilevel application of this invention. The CC process works better than other processes used for document management that rely on non-linguistic means to characterize documents. Simple keyword searches either retrieve too many documents (for general keywords), or not the right documents (because a few keywords cannot adequately define a category), no matter how complex the logic of the search. Application of statistical analysis without attention to linguistic principles cannot be as effective as this invention, because the words of a language are not randomly distributed. The assumptions of statistics, whether simple inferential tests or advanced neural network analysis, are thus not a good fit for language. This invention puts basic principles of language first, and only then applies the speed of computer searches and the power of inferential statistics to the problem of evaluation and categorization of textual documents.

### PRIORITY CLAIM TO RELATED APPLICATION

This application claims the benefit of U.S. Provisional Application No. 60/585,179 filed 2 Jul. 2005, which is hereby incorporated by reference herein as if fully set forth below.

### TECHNICAL FIELD

The invention relates generally to linguistics, and more specifically to corpus linguistics. The invention is also related to natural language processing, data mining, and computer-assisted information processing, including document classification and content evaluation.

### BACKGROUND

The modern development of the field of corpus linguistics has moved beyond the merely technical problems of the collection and maintenance of large bodies of textual data. Availability of full-text searchable corpora has allowed linguists to make substantial advances in the study of speech (i.e. real language in use), as opposed to the traditional study of language systems, as such systems are described in the assertion of relatively fixed syntactic relations in grammars, or in hierarchies of word meaning in dictionaries.

Corpus-based studies of language have shown that speech is a much more varied and various phenomenon that ever was supposed before storage and close analysis of large bodies of text became possible. Some studies have pointed to the importance of word co-occurrence, or collocation, as an important constituent of the way that speech works, at least as important as grammar. Collocations are considered to exist within a certain span (distance in words to the right or left) of a node word, so that valid collocations often exist as discontinuous strings of characters, or as schemas or frameworks with multiple variable elements. A collocational approach was applied to lexicography for the first time in Collins' COBUILD English Language Dictionary.

At nearly the same time, it was shown that different grammatical tendencies belonged to different text types, and that speech and writing tended to occur in superordinate dimensions. Findings have suggested that, in effect, every text had its own grammar, in the sense that every text realized different grammatical possibilities at different frequencies of occurrence. More recently, corpus linguists have come more and more to realize that the freedom to combine words in text is much more restricted than often realized, and that particular passages of particular texts can be characterized as having lexical cohesion. That is, instead of traditional models of rule-based grammars or hierarchical dictionaries, corpus linguistics has demonstrated Firth's principle that words are known by the company they keep.

Yet more recently, ideas like these have been applied beyond linguistics in fields such as psychology, in which the authors apply restrictions on both grammatical and lexical choices to try to identify what they call “deceptive communication.” Thus, at this point, it is both theoretically reasonable and practically possible to attempt automated evaluation of documents by using linguistic collocational methods. This task is essentially different from keyword searches of texts, because all modern search algorithms limit such searches to only a few words at a time with Boolean operators, allow only limited use of proximity as a search tool, and return only documents which slavishly adhere to the keyword search criteria. This task is also essentially different from the creation of indices, such as those developed with n-gram methods. Instead, evaluation with collocational methods can serve both to group documents that exhibit similar kinds of “lexical cohesion” and to identify parts of documents that show “lexical cohesion” of interest to the analyst.

Previous approaches to text searching and automatic document classification relied on purely mathematical analyses to group documents into sets, particularly given a user-defined prompt. An example is Roitblat's process for retrieval of documents using context-relevant semantic profiles (U.S. Pat. No. 6,189,002). This process applies a neural network algorithm and the standard statistic Principal Components Analysis (PCA) to derive clusters of documents with similar vocabulary vectors (i.e. presence of absence of particular words anywhere in a document). As was pointed out a decade earlier, however, this model is a poor fit for texts: this “open choice” or “slot-and-filler” model assumes that texts are loci in which virtually any word can occur, but it is clear that words do not occur at random in a text, and that the open-choice principle does not provide for substantial enough restraints on consecutive choices: we would not produce normal text simply by operating the open-choice principle. Further, neural networks in particular require training on an ideal text corpus, and the findings of modern corpus linguistics suggest that there is no such thing as an ideal text or text corpus given the high degree of variation within and between different texts and text corpora. Thus such mathematical models may well return results when applied to sets of textual documents, but the recall and precision of the results are not likely to be high, and the text groupings yielded by the process will necessarily be difficult to interpret and impossible to validate.

Previous approaches to text searching and automatic document classification attempted to use the frequency of strings of characters (a keyword or words in sequence) in a document to group documents into categories. An example is Smajda's process for automatic categorization of documents based on textual content (U.S. Pat. No. 6,621,930). This process applies an algorithm deriving Z-scores from comparisons of a training document to target documents. As above, modern corpus linguistics suggests that the high linguistic variability of features of particular texts argues against the existence of ideal training documents. Moreover, the use of individual words or consecutive strings of characters over many sequential words is also not in conformance with the findings of modern corpus linguistics.

No method that relies on keywords or word sequences alone, no matter its statistical processing, can address the discontinuous and highly variable realizations of collocations in textual documents. One known method yields only a relatively weak success rate of about 60% correct assignment of documents regarding the category “deceptive communication” most likely because their process uses single words and does not reflect variable realizations of collocations.

Some previous approaches to automatic document classification have attempted to use surface characteristics (words and non-word textual features such as punctuation) to classify documents into categories. An example is Nunberg's process for automatically filtering information retrieval results using text genre (U.S. Pat. No. 6,505,150). While this approach is promising, in that items from the long list of surface cues (such as marks of punctuation, sentences beginning with conjunctions, use of roman numerals, and others) have been shown to vary with statistical significance between documents and document types in modern corpus linguistic research, it is aimed at “text genres” such as “newspaper stories, novels and scientific articles,” and thus is not designed to evaluate documents according to user-defined discourse types or to identify passages that show lexical cohesion.

Accordingly, there is a need in the art for a technical solution capable of evaluating large sets of documents and extracting specific data and information from large sets of documents.

There is also a need in the art for a scalable, flexible technical research tool that utilizes technical features capable of providing a user with a specific information set from a vast collection of documents based on a user's needs.

There is also a need in the art for a technical research tool capable of implementing a collocation cohesion evaluation process utilizing technical features to provide a precise information set found in a large set of documents.

It is to the provision of such automated evaluation systems and methods utilizing technical features that the embodiments of present invention are primarily directed.

### BRIEF SUMMARY OF THE INVENTION

The various embodiments of the present invention employ the state of the art in modern corpus linguistics to accomplish automated evaluation of textual documents by collocational cohesion. The embodiments of the present invention do not rely in the first instance upon mathematical methods that do not effectively model the distribution of words in language. Instead the embodiments accept a variationist model for linguistic distributions, and allow mathematical processing later to validate judgments made about distributions described in terms of their linguistic properties.

Above all, the various embodiments of the present invention consist of the deliberate application of linguistic knowledge to problems of document evaluation, rather than the ex post facto evaluation normally applied to methods that depend on mathematical models. So the embodiments of the invention are not only more accurate in document evaluation, but also more responsive to the particular needs of the task that motivates any particular instance of document evaluation. The embodiments of the present invention utilize corpus linguistics to create validatable classifications of textual documents into categories, with an assigned rate of precision and recall, and identify passages which show collocational cohesion.

When utilized, a preferred embodiment of the invention can evaluate a large set of documents (e.g., 50 million documents) to identify a small set of documents (e.g., 50 documents) with a size and with a degree of accuracy specified by a user. The small set of documents are most likely to be members of the particular class of documents, those conforming to a particular discourse type, specified in advance by a user so that the user can review the small set of documents rather than the large set of documents. Thus, the various embodiments of the present invention enable research tasks to be more efficient while at the same time lowering costs associated with research tasks. The embodiments of the present invention also provide a flexible scalable evaluation system and method that is adaptable to any scale research project needed by a user. For example, an embodiment of the present invention can be utilized to search, classify, or organize 50 million documents and another embodiment can be used to search, classify, or organize 10 thousand documents. Those skilled in the art will understand that the various embodiments of the invention can be utilized in numerous applications attempting to extract precise information from a large set of documents.

Briefly described, a preferred embodiment of the present invention can be a process that works by means of linguistic principles, specifically Collocational Cohesion. Everyday communication (letters, reports, e-mails, and all kinds and types of communication in language) do follow the grammatical patterns of a language, but forms of communication also follow other patterns that analysts can specify but that are not obvious to their authors. The embodiments of the present invention can utilize this additional information for the purposes of its users. This information can consist of the particular vocabulary as it is arranged into collocations as elsewhere herein defined, that can be shown to be significantly associated with a particular discourse type; grammatical characteristics, and potentially other formal characteristics of written language, may also be identified as being significantly associated with a particular discourse type. Any communication exchange that can be recognized by human readers as a particular kind of discourse may be used as a category for classification and assessment. Specific linguistic characteristics that belong to the kind of discourse under study can be asserted and compared with a body of general language, both by inspection and by mathematical tests of significance.

These characteristics can then be used to form a roster of words and collocations that specifies the discourse type and defines the category. When such a roster is applied to collections of documents, any document with a sufficient number of connections to the roster will be deemed to be a member of the category. Larger documents can be evaluated for clusters of connections, either to identify portions of the larger document for further review, or to subcategorize portions with different linguistic characteristics. The process may be extended to create a roster of rosters belonging to many categories, thereby increasing the specificity of evaluation by multilevel application of this invention.

In one preferred embodiment of the invention, a method to evaluate a set of materials containing text to determine if the materials contain information related to a user-defined query regarding content or formal characteristics of a text is provided. The method can comprise selecting a discourse type as a classification category and creating a word roster comprising a plurality of words. The method can also include testing the plurality of words in the word roster and comparing the words in the word roster with a plurality of textual materials. The method can also include generating a profile for each of the textual materials and producing the materials having information related to the discourse type.

In another preferred embodiment of the invention, an automated evaluation system is provided. The automated evaluation system can comprise a memory and a processor. The memory can store a word roster comprising a plurality of words. The plurality of words can be associated with a chosen discourse type, search field, or subject. The processor can compare the words with a plurality of textual materials, generate a profile for each of the textual materials based on the word comparison, and determine the textual materials having information related to the discourse type, search field, or subject.

In another preferred embodiment of the present invention, a method of creating a roster of words for evaluating a plurality of documents is provided. The method can comprise selecting a plurality of words associated with a discourse type and comparing the words to a balanced corpus. The method can also include testing the words to determine collacational characteristics of the words relative to the balanced corpus and adjusting the word roster for preparation of comparing the word roster to a set of documents, textual materials, or text-based information that a user desires to search or classify.

In yet another preferred embodiment of the present invention, a method of evaluating a plurality of textual documents to obtain information related to a discourse type is provided. The method can comprise comparing a plurality of words associated with the discourse type to a plurality of documents to determine if text in the documents matches at least one of the plurality of words and generating an index for each of the documents based on the comparison of each of the documents and the words. The method can also include providing a first subset of the documents based on the index of each document and identifying word spans in the subset of documents. The method can further comprise providing a second subset of the documents corresponding to the plurality of words, wherein the second subset of documents correspond to the discourse type.

In yet another preferred embodiment of the present invention, a processor implemented method to evaluate a set of documents to determine a subset of the documents associated with a discourse type is provided. The processor implemented method can comprise testing a plurality of words in a word roster against a balanced corpus and comparing the words in the word roster to the set of documents. The method can also include generating a profile for each of the documents and producing the documents having information related to the discourse type.

In still yet another preferred embodiment of the present invention a method to evaluate a set of textual documents utilizing multiple word rosters is provided. The method can comprise developing multiple word rosters, each word roster associated with a discourse type, and testing each of the word rosters against the set of textual documents to provide a ranking of the textual documents for each word roster. The method can also include generating a subset of textual documents having connections with at least one of the discourse types and classifying each of the textual documents based on the connection between each document and the discourse types.

These and other objects, features, and advantages of the present invention will become more apparent upon reading the following specification in conjunction with the accompanying drawings.

### BRIEF DESCRIPTION OF THE DRAWINGS

FIG. 1 illustrates a logical flow diagram of a method of providing a word roster for evaluating a set of documents according to an embodiment of the present invention to evaluate a set of documents.

FIG. 2 illustrates a distributional pattern of an application of an embodiment of the present invention to a set of documents, including both a table and graph.

FIG. 3 illustrates a logical flow diagram of a method of evaluating a set of documents according to an embodiment of the present invention to evaluate a set of documents.

FIG. 4 illustrates a logical flow diagram of a method of evaluate one or more sets of textual documents utilizing multiple word rosters according to an embodiment of the present invention.

### DETAILED DESCRIPTION OF PREFERRED EMBODIMENTS

The embodiments of the present invention are directed toward automated evaluation systems and methods to evaluate a large set of documents to produce a much smaller set of documents that are most likely, with a specific degree of the precision (getting just the right documents) and recall (getting all the right documents), to be members of the discourse type defined in advance by the user. The various embodiments of the present invention provide novel methods and systems enabling efficient natural language processing, data mining, and computer-assisted information processing, including document classification and content evaluation. The systems and methods disclosed herein produce useful results utilizing technical features useful in numerous industrial applications to yield useful results. For convenience and in accordance with applicable disclosure requirements, the following definitions apply to the various embodiments of the present invention. These definitions supplement the ordinary meanings of the below terms and should not be considered as limiting the scope of the below terms.

Collocate/Collocation: any word which is found to occur in proximity to a node word is a collocate; the combination of the node word and the collocate constitute a collocation; more generally, collocation is the co-occurrence of words of texts.

Connection: one token of a match between a roster entry and language found in a document. Any given document may contain many connections.

Discourse type: any style or genre of speaking or writing that is recognizable as itself, in contrast to other possible discourse types, and realized as a document.

Document: a single example of any manner of communication (written or spoken) in any medium (printed, electronic, oral) of any size. A document can be a digital file in text format and can be in a single file.

Document profile: a record of the characteristics of a document, including connections to rosters, unweighted ranks, and weighted ranks, after processing by one or more rosters. A document profile may also include many other characteristics related to a document.

Node (word): a word which is the subject of analysis for collocation.

Roster: A word list related to a discourse type, especially after it has been augmented with collocational information in roster entry format.

Roster Entry: a set of information about the collocational status of a word in a roster (see roster).

Span: a distance expressed in words either to the right of to the left of a node word.

Text block: any number of running words that occur consecutively in a text.

Referring now to the drawings, FIG. 1 illustrates a logical flow diagram of a method 100 of the present invention to evaluate a set of documents. A first step (A1) in the method 100 is identification of a discourse type to serve as a category for classification. Such categories may correspond, for example, to one or more different business areas, such as finance, marketing, and manufacturing. They may also correspond to more affective discourse types, such as complaints and compliments (as from a collection of comment documents), or even love letters. The only constraint on the identification of a discourse type is that documents of the type must be recognizable as such by people who receive (read or hear) them.

“Prediction” can, for example, serve as a recognizable discourse type. People generally know when a prediction is being made, as opposed to alternative discourse types such as “historical account” or “statement of current fact.” “Prediction” overlaps with other imaginable discourse types such as “offer” and “threat,” which illustrates the need for care in the selection of linguistic characteristics belonging to any conceivable discourse type. To continue the example, “prediction” always includes language that refers to the future, unlike language that refers to the past for a “historical account” or to the present for a “statement of current fact.” Any particular text that qualifies as a “prediction” may be either positive or negative, or reflect an opportunity or a danger, and so “prediction” as a type encompasses both “offer” and “threat,” which both refer to the future but which are either positive or negative, representing opportunity or danger, respectively. “Offer” and “threat” may optionally be distinguished from “prediction” on grounds that they are conditional states of affairs, while “prediction” is speculative.

Thus the selection of a particular discourse type, or array of discourse types, requires careful analysis of the properties of each type, especially as each type may be related to other possible types, given the requirements of the task at hand. There is no standard set of discourse types, although some types may be more ad hoc (i.e., recognized only by members of a particular group) and some types may be recognized more generally.

A next step (A2) in the method 100 shown in FIG. 1 is creating a roster of words associated with the chosen discourse type. The roster of words can be chosen from experience with a discourse type and/or from inspecting discourse type examples. Some documents are more recognizable as members of a discourse type, and others less recognizable, but still members of a discourse type. No document can serve as an ideal exemplar of a type, because no document will consist of all and only the characteristics associated with a discourse type. Thus, the creation of an initial roster for a discourse type cannot rely on any single particular document.

An initial roster may be created from the properties that belong to a chosen discourse type. While no individual document can serve as a model, available documents that are recognized as belonging to the discourse type may suggest entries for the roster, so long as they are measured against the properties deemed to belong to the discourse type. So, for the “prediction” example, words that have to do with the idea of prediction can be included: “prediction, announcement, premonition, intuition, prophecy, prognosis, forecast, prototype, foresight, expectation,” and others. Verbal and adjectival words can also be included: “predict, foretell, bode, portend, foreshadow, foresee, expect, predicting, predictive, prophetic, ominous;” and others. English words are often created by the addition of inflectional and other endings to root or base forms, such as “predict” plus “-ing,” “ed,” “-s” (inflectional endings), or “-tion,” “-able,” “-ive” (non-inflectional endings). All relevant derived forms can be included in the initial roster, because the derived forms may be more frequent in use than the base form, and may be significantly associated with different discourse types than the base form. The length of the roster depends on the specificity of the properties identified for the discourse type; more extensive sets are not necessarily better.

A next step (A3) in the method 100 shown in FIG. 1 can be to test the created roster of words. Such testing can include testing each word from the roster against a balanced corpus to determine how frequent the words in the roster of words appear in the balanced corpus. For example, this testing can determine the relative frequency of the word, and whether the word is significantly associated with any sub-areas of the balanced corpus. While all words chosen for the roster will be relevant to the selected discourse type, not all words may be equally useful for automatic document evaluation. Actual normal usage of each word can be estimated from its frequency overall in a balanced corpus (i.e., a corpus of significant size composed of documents selected to represent many different kinds of texts and text genres; an early example is the one million word Brown Corpus, designed as a balanced representation of American written English at the time of its creation).

Comparison of word frequencies can be accomplished with common statistics such as the “proportion test” (which yields a Z-score). Other statistical methods and analysis algorithms can also be utilized which the investigators deem useful for the comparison. Moreover, each word in the roster can be measured against a sub-corpus in the balanced corpus, to establish whether particular genres or text types contribute a disproportionate share of the word's overall frequency. Words may be dropped from the roster if the analysis shows that they are too frequent or too infrequent in the balanced corpus to contribute usefully to document evaluation, or if they are particularly associated with some sub-corpus. For example, the words “prophecy” or “augury” might be dropped from the “prediction” list if the list had been composed to support business predictions, and these entries were deemed to occur mostly in religious documents; “premonition” and “intuition” might be dropped if they were thought to be unintentional forms of “prediction” when only intentional predictions were desired.

A next step (A4) in the method 100 shown in FIG. 1 can be to test the created roster of words for collocations. Such testing can include testing each word from the roster for its most likely collocations within the balanced corpus, both within the roster for the discourse type and among words not included in the roster for the discourse type. As described above, modern corpus linguistics processes collocations by examining a node word within a certain span of words to discover particular collocates of significant frequency. For example, the word “prediction” is often used in the phrase “make a/the/that/(etc) prediction,” so a corpus linguist would say that the word “make” frequently occurs within a span of two words left of the node word “prediction.” So-called “content words” (as distinguished from “function words” like articles, prepositions, conjunctions, auxiliary verbs, and others) commonly co-occur with particular verbs or other content words, whether in phrases (like the verb phrase “make prediction”) or simply in proximity.

The word roster as adjusted in Step A3 can be tested against the balanced corpus to generate frequencies of collocations in use (collocation factor), both with other words from the roster and with words not already found in the roster. The results of the test will be applied back to the roster as in Step A3, so that some words may be eliminated from the roster because the collocation data makes them undesirable for document evaluation. Words in the roster may also be coded to indicate that, to contribute usefully to document evaluation, they must, or must not, occur in the presence of certain collocates. For example, the list may specify that the node word “prediction,” when within a short span of “make,” may not also have the words “refuse,” “not,” or “never” within a short span (because such negative words can indicate that a prediction is not being made there).

The collocational characteristics of a word in the roster can be represented with a roster entry. For example, a collocation factor can be a set of collocation factors. Each roster entry can constitute a specific, empirically derived set of characteristics that corresponds in whole or in part to a property deemed to belong to the discourse type under study.

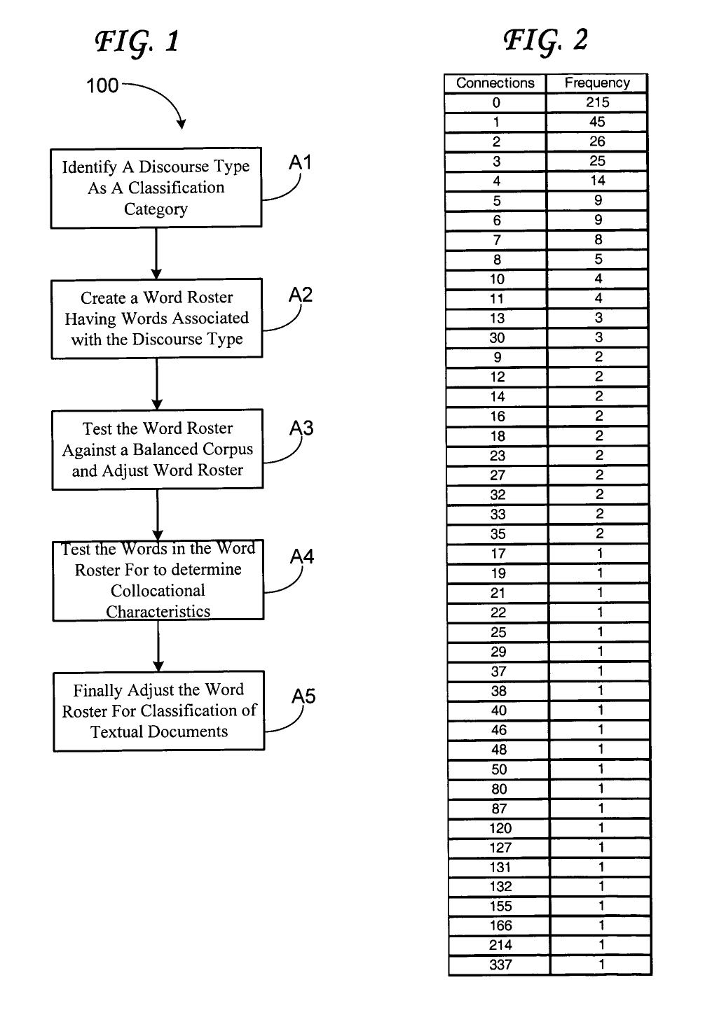

FIG. 2 illustrates the results of application of a roster containing 415 roster entries against a large collection of documents in a balanced corpus. A total of 3016 connections occurred between particular roster entries and particular documents; the total number of connections is the sum of the number of connections times the frequency (e.g., 3016=(1×45)+(2×26)+(3×25) . . . +(337×1)). For the roster containing 415 roster entries, 215 different roster entries yielded no connections; these roster entries would be candidates for removal from the roster because they may not be useful for evaluation of documents of the discourse type under study. There were also a few roster entries that yielded over 100 connections (e.g., 120, 127, 131, 132, 155, 166, 214, 337); these roster entries would also be candidates for removal from the roster because they may have too great a yield to be useful for evaluation of documents of the discourse type under study.

The general distribution of frequencies of connections follows an asymptotic hyperbolic curve that commonly describes distributions of linguistic features and frequencies (see Kretzschmar and Tamasi 2003), and so may be used to control the efficiency of the roster. For example, elimination of roster entries that did not yield at least three connections (about 7% of actual connection frequencies in this case) would reduce the size of the roster from 415 roster entries to 129 roster entries. Alternatively, removal of the five top-yielding roster entries from the list (about 1% of the roster entries in the roster) would reduce the number of connections by 1004 (33%). Experience and testing with large rosters and large document sets suggests that these adjustments, removal of roster entries without at least three connections and removal of the top-yielding 1% of roster entries, is an effective practice for roster modification.

A next step (A5) in the method 100 shown in FIG. 1 can be to finally adjust the word roster. The final adjustment of the word roster can prepare the word roster for the discourse type under study. The previous steps (A1-4) of method 100 create a considerable body of information about the behavior in use of each word of the roster. This information may be used to refine the properties of the discourse type, so that whole groups of words may be added to or deleted from the roster. So, for example, future-tense verb forms might all be eliminated from the “prediction” roster if they were found to yield too many or too few connections to be of use. The information may also be used to weight entries in the word list. For example, for the discourse type “prediction,” the word “prediction” might be weighted as three times more important in document evaluation than other unweighted words in the word list, because whenever the word occurs it is highly likely to be used in documents of the “prediction” type.

Adjustment of properties or weights may require further comparison of the roster with the balanced corpus. In particular, the roster can be applied again to the balanced corpus to establish that any addition or removal of roster entries and creation of weights still results in a significant association of the roster with the discourse type under study and not with all or part of the balanced corpus. At the end of this step, the roster consists of all words deemed to be useful for evaluating documents of a particular discourse type, and each word will be accompanied by collocational information in roster entry format that specifies conditions under which it will be used for document evaluation, and an optional weight for use in document evaluation. A sample of a word roster having “collocational” information is shown in the below Table (TABLE A).

TABLE A

| | | | Allow | | | |
|---|---|---|---|---|---|---|
| Word | Include | Exclude | Neg. | +Collocate | −Collocate | Weight |
| Augury | | (all) | | | | |
| Expectation | -s | | Yes | below, above, | great, Pip, high, | 1 |
| | | | | future | live up | |
| Forecast | -ing, er, | | No | accurate, | weather, rain, | 2 |
| | ers, -s | | | economic, | temperature, | |
| | | | | future | ability, method | |
| Offer | | (all) | | | | |
| Predict | -ed, -ing, | -ability, -able, | No | make | Soothsayer, | 3 |
| | -tion, -tions, | ably, ive | | | difficult, fate | |
| | -or, ors, -s | | | | | |
| Prognos* | -is, -es, | | Yes | | Medical, | 1 |
| | -tication, | | | | disease, illness | |
| | -ticator | | | | | |
| Prophecy | | (all) | | | | |
| Threat | | (all) | | | | |

Following the creation of a roster for the discourse type under study, the roster should be applied to a set of unknown textual documents, as described in detail below, to discover documents most likely to be examples of the discourse type, and to identify passages that show collocational cohesion of interest. For the purpose of providing examples in the below discussion, the small roster of TABLE A will be used to evaluate a small set of 500 documents for documents of the “prediction” discourse type. In commercial or legal uses of the invention, users may expect to use large rosters (i.e. with hundreds of entries), in order to evaluate large document sets (i.e., containing thousands or millions of documents).

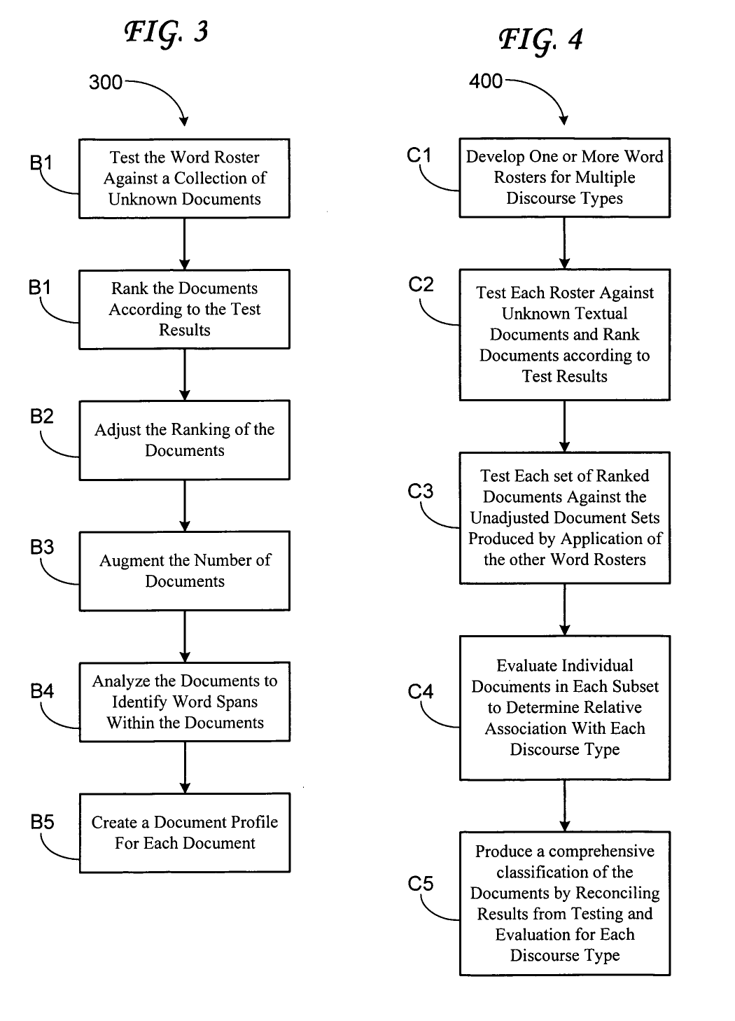

A next step of a method 300 according to a preferred embodiment of the present invention comprises comparing a word roster created in Steps A1-A5 to a set of unknown textual documents. For example and as shown in FIG. 3, Step (B1) can consist of testing the roster developed in Steps A1-A5 against a collection of unknown textual documents. The results of this testing can yield a ranking of documents by the number of connections shown between individual documents and the roster. In addition, the results of this testing can produce a subset of the documents containing information related to the chosen discourse type. The source of the unknown textual documents may be the Internet, or collections of documents from any institution or person. Other examples of textual documents include collections of e-mails, textual documents such as reports or correspondence recovered from computer storage, and textual documents in hard copy that have been scanned and processed into digital texts. The set of unknown documents preferably contains at least some examples of the chosen discourse type.

Every document in the set of unknown documents should be measured against the roster, and a count should be made for the number of times that text stings of the document match entries in the roster (a text string refers refers to a match for a roster entry, like “forecast” but not “weather forecast”). For example, if the word “forecast” is an entry in the word roster, and it occurs three times in a document (e.g., “Document X”), but no other entries from the roster appear, then Document X would receive an initial unweighted score of 3. An unweighted value for every document in the set is preferably established in this manner, and each document in the set should then be ranked according to its unweighted score. It is expected that a wide range of unweighted scores will be present in any large collection of unknown documents, in accordance with the expectation of a hyperbolic asymptotic distribution.

A next step (B2) in the method 300 shown in FIG. 3 can be to adjust the ranking of the documents. For example, such adjustment can include adjusting the ranking according to the weights of individual components of the roster. Weights from the roster that were assigned in Step A5 steps should be applied to the scores of each document to create a new indexed value for each document, and the documents should be ranked again by the indexed value. For example, since “forecast” received a weight of 2 in the sample roster in TABLE A, the unweighted value of Document X with three occurrences of “forecast” would become a weighted value of 6 (by multiplying the weight against the unweighted value). Thus, Document X would be expected to have a higher ranking among all the documents ranked, because it included a roster entry that was considered important and thus highly weighted. The weighted rank minus the unweighted rank gives an indication of the presence and magnitude of weighted connections. Subtracting the unweighted rank of Document X from its weighted rank would thus yield a positive value, whereas some document whose rank became lower because it did not contain more heavily weighted roster entries would have a negative value from this comparison.

A next step (B3) in the method 300 shown in FIG. 3 can include augmenting the number of documents. For example, to establish the set of documents from the overall document set that are most likely to be members of the discourse type, Step (B3) can comprise removing the highest ranking and lowest ranking documents from the set of ranked documents, according to the needs for recall and precision of the purpose of the application. “Precision” means getting just the right documents from the target set, and “recall” means getting all the right documents from the target set.

Many documents will contain no connection with the roster, and therefore will be unlikely to be members of the discourse type under study. Some documents will contain a very high number of connections. These documents are also not likely to be members of the discourse type under study, because their number of connections suggests that they may be discussions about the discourse type under study, rather than examples of the discourse type under study. Documents with only one or two connections are less likely to be members of the discourse type than documents with moderate numbers of connections. The inventor has discovered through experience and testing that documents with positive values for the weighted/unweighted rank metric are more likely to be members of the discourse type, unless their overall number of connections is very high. For example, in a set of 500 documents prepared as an example for the “prediction” discourse type, only 68 documents contained connections to any of the roster entries in TABLE A. Of these 68 documents, 52 documents contained only one connection; 7 documents contained two connections; 6 documents contained three connections; and one document each contained four, five, and six connections.

Given these general principles, it is possible to select a number of documents most likely to be members of the discourse type based on the needs of the task. If the task requires selection of all documents of a class and is not sensitive to “false hits” (i.e. favors recall), then a wide range of ranks may be applied. If the task requires that only the most likely members of a discourse type be selected (i.e. favors precision), then a smaller range of ranks may be applied. In the 500-document “prediction” example, we can exclude the documents with a single connection, leaving only 16 of the original 500. While the small size of the example suggests that documents with the most connections not be automatically excluded (because their number is small enough to be validated in any case), as would be the case in applications to large document sets, it is preferable to exclude the three highest-ranking documents. This would leave only 13 documents in the classification set.

The accuracy of the process may be validated by inspecting the ranked documents selected. Validation may suggest additional modification of the roster and reapplication of Steps A5-B3. In the 500-document “prediction” example, two of the three documents with the most connections were methodological documents about making predictions (in science), and the other was an editorial piece about predictions made by others, so these documents could rightfully be excluded from the “prediction” discourse type. Of the remaining thirteen documents, inspection shows that 11 of the documents contained actual predictions, and the other two documents contained predictions that had already come to pass.

A next step (B4) in the method 300 shown in FIG. 3 can include analyzing the documents to identify word spans within the documents. For example, Step (B4) can include identification of spans of words within documents that contain clusters of connections. Some documents are quite long while others are short, and so it will be useful to consider not only the number of connections per document but also whether the connections occur in immediate proximity. As discussed above, occurrence in proximity is important because it yields “collocational cohesion.” In the brief 500-document example set for “prediction,” some of the documents were completely devoted to prediction, but most contained sections or passages that constituted “prediction” in the course of discussion about other topics. The several connections identified for the entire document from the example set typically occur within a few sentences of each other. In such cases it is possible therefore to consider the entire document as belonging to the “prediction” discourse type, because at least part of the document constitutes a prediction. However, for many purposes it will be desirable to identify just those passages which can be identified as “prediction” without so classifying the entire document.

To address this goal, for each document in the set, a computer program can be written to identify the first fifty running words, count the number of connections within that text block, and store the value for this first text block in a table. The program would then then step forward by ten,words in the document and again count connections within a fifty word text block (i.e. from word 10 to word 60), and store the value in the table. The program would then continue to step forward by ten words to make a new text block, and store the number of connections for each text block in a table. All of the text blocks in the document set should then be ranked, first by unweighted rank and then by weighted rank as described in Steps B1-B3, on the basis of fifty-word text blocks. This procedure will identify the text blocks in which the connections occur, and thus allow specific parts of documents to be evaluated as belonging to the discourse type under study; this procedure also allows documents to be classified as belonging to multiple discourse types, as different text blocks in the same document can be shown to have connections from the rosters of different discourse types.

A next step (B5) in the method 300 shown in FIG. 3 can include creating a document profile for each document. For example, Step (B5) can comprise creating a document profile for each document in the set that records its metadata (information such as the author of the document, and creation date), its number of connections, unweighted and weighted rankings by document in the set, the connections found, and the passages with clusters of connections with their unweighted and weighted rankings within the set. Relevant metadata can include (at least) the author(s), recipient(s), date, length in words, and any prior designations or classifications applied to the document. Document profiles may contain connection information from more than one discourse type, segregated by discourse type. Document profiles thus constitute a record of the evidence in the document relevant to evaluation, and further evaluation of documents in the set may take place on the set of document profiles rather than on the documents themselves. A sample document profile is shown below in TABLE B.

TABLE B
Metadata: John R. Sargent, “Where To Aim Your Planning for Bigger
Profits in '60s,” Food Engineering, 33:2 (February, 1961)
34-37. 2000 words recorded in the Brown Corpus. 500-document
“prediction” example set
Discourse type: prediction. Forecast, 3. Unw rank: 4. W rank: 4. Text
blocks: not run.

Another embodiment of the present invention includes evaluating a set of textual documents with multiple word rosters. For example, and as shown in FIG. 4, another method embodiment 400 is evaluating a set of unknown textual documents with multiple rosters as described in Steps A1-B5 to achieve comprehensive classification of the document set. Accordingly, the method 400 may comprise steps C1-C5 detailed as follows.

Step (C1) can consist of developing of one or more word rosters for multiple discourse types, as indicated in Steps A1-A5.

Step (C2) can include testing each roster against a collection of unknown textual documents to yield a ranking of documents by the number of connections shown between individual documents and each roster, as in Steps B1-B2.

Step (C3) can consist of testing each set of ranked documents against the unadjusted sets of documents produced by application of the other rosters (Steps B1-B2) to yield subsets of documents that have connections with one or more additional discourse types. The document profile for each roster can then be augmented to store information relevant to other rosters.

Step (C4) can include evaluating individual documents within each subset to determine relative involvement of each discourse type in each document, and adjustment of each subset according to the evaluation. Some documents will clearly be most closely associated with a single roster, while others may show numerous connections with multiple rosters. Information from Step B4 may indicate that particular passages in documents correspond to different discourse types. Documents may then be classified as examples of individual rosters (including one document as an example of more than one roster), but also as examples of hybrid discourse types composed of the intersection of two or more of the discourse types under study.

A last step in the process (C5) can include reconciliation of results from testing and evaluation for each discourse type to produce a comprehensive classification of the document set. For example, a business with a large number of unclassified documents will be interested, under current legal standards, to evaluate the documents and classify them. Different businesses will have different categories (i.e., discourse types) into which documents need to be classified, depending on organizational and operational criteria specific to the business. Comprehensive document classification can evaluate each document, either as a whole or as text blocks, in order to group documents into the categories needed by the business, whether into general business categories or into categories that reflect different products or business operations. Relationships between the set of discourse types originally defined may suggest that a larger of smaller number of discourse types be applied to the comprehensive analysis, and so may suggest reapplication of the process from the beginning. Relationships between discourse types may also suggest modification of the rosters in use for each type, so as to limit or highlight particular relationships according to the particular needs of the overall task.

The various embodiments of the invention enables companies to manage (evaluate, classify, and organize) their textual documents, or legal counsel to manage documents in discovery, whether the documents are originally in or are converted to digital text form. A preferred embodiment of the invention can be used to organize document sets, or to review document sets for particular content or for general or specific risks. Boards of directors and corporate counsel can use the invention to help evaluate corporate information without having to create elaborate systems of reporting. The various embodiments of the invention can be a shrink-wrap product, but in its preferred form it's a scalable, flexible approach enabling users to create various discourse and categories for evaluating a large set of documents for specific information. In other words, the various embodiments of the present invention can be narrowly tailored for a user's needs. The chosen discourse types can be continuously refined given the experience of processing relevant documents, or the invention can be used with little additional consulting, at the option of the client.

A preferred embodiment of the present invention can be utilized in conjunction with a computing system and various other technical features. For example, a computing system can have various input/output (I/O) interfaces to receive and provide information to a user. For example, the computing system can include a monitor, printer, or other display device, and a keyboard, mouse, trackball, scanner, or other input data device. These devices can be used to provide digital text to a memory or processor. The computing system can also include a processor for processing data and application instructions and source code for implementing one or more components of the present invention. The computing system can also include networking interfaces enabling the computing system to access a network such that the computing system can receive or provide information to and from one or more networks. The computing system can also include one or more memories (hard disk drives, RAM, volatile, and non-volatile) for storing data. The one or memories can also store instructions and be responsive to requests from a processor.

Those skilled in the art will understand that a wide variety of computing systems, such as wired and wireless, computing systems can be utilized according to the embodiments of the present invention. In some embodiments, the computing system may be a large-scale computer, such as a supercomputer, enabling a large set of documents to be efficiently and adequately processed. Other types of computing systems include many other electronic devices equipped with processors, I/O interfaces, and one or more memories capable of executing, implementing, storing, or processing software or other machine readable code. Accordingly, some components of the embodiments of the present invention can be encoded as instructions stored in a memory, a processor implemented method, or a system comprising one or more of the above described components for evaluating a set of documents in response to a user's instructions.

While the invention has been disclosed in its preferred forms, it will be apparent to those skilled in the art that many modifications, additions, and deletions can be made therein without departing from the spirit and scope of the invention and its equivalents, as set forth in the following claims.

1. A method to evaluate a set of materials containing text to determine if the materials contain information related to a user-defined query regarding content or formal characteristics, the method comprising:
selecting a discourse type as a classification category;
creating a word roster comprising a plurality of words;
testing the plurality of words in the word roster;
comparing the words in the word roster with a plurality of textual materials;
generating a profile for each of the textual materials; and
producing the materials having information related to the discourse type.

2. The method of claim 1, wherein creating a word roster comprises words related to the discourse type.

3. The method of claim 1, wherein creating a word roster comprises selecting derived forms of the words in the word roster.

4. The method of claim 1, wherein creating a word roster comprises selecting words that are either permitted or not permitted to occur within a predetermined proximity of a word in the word roster.

5. The method of claim 3, wherein derived forms of a word comprise: verbal derived words, adjectival derived words, inflectional derived words, and non-inflectional derived words.

6. The method of claim 1, wherein testing the plurality of words in the word roster comprises comparing the words in the word roster to a balanced corpus.

7. The method of claim 6, further comprising determining the frequency of one of the words in the word roster in the balanced corpus.

8. The method of claim 6, further determining if one of the words in the word roster is associated with a sub-area of the balanced corpus.

9. The method of claim 6, further comprising comparing the frequency of one word in the word roster in the balanced corpus with the frequency of another word in the word roster in the balanced corpus.

10. The method of claim 9, further comprising utilizing a proportion test to compare word frequency of the words in the word roster in the balanced corpus.

11. The method of claim 1, further comprising measuring one word in the word roster against a sub-corpus to determine if a text genre contributes to the frequency of the one word in the balanced corpus.

12. The method of claim 1, further comprising adjusting the word roster by removing a word from the word roster.

13. The method of claim 12, wherein removing a word from the word roster comprises determining if the usage frequency of the word exceeds a too frequent threshold or falls below an infrequent threshold.

14. The method of claim 12, wherein removing a word from the word roster comprises determining if the word is associated with a sub-corpus of the balanced corpus.

15. The method of claim 1, wherein testing the roster of words comprises testing one of the words in the word roster to determine a collocation factor of the word in a balanced corpus.

16. The method of claim 15, further comprising adjusting the word roster based on the collocation factors for each of the words.

17. The method of claim 15, further comprising coding one word in the word roster based on its collocation factor.

18. The method of claim 17, further comprising removing one word from the word roster if its collocation factor falls below or exceeds a predetermined collocation factor threshold.

19. The method of claim 15, further comprising determining a span for a roster word based on its collocation factor.

20. The method of claim 19, wherein determining a span for a roster word includes determining if one word in the word roster can appear within the span for a roster word.

21-60. (canceled)
